(19) United States
(12) Patent Application Publication
(10) Pub. No.: US 2012/0303506 A1
(43) Pub. Date: Nov. 29, 2012

(54) System and Method for Auctioning in a Multiple Seller / Single Buyer Environment

(76) Inventors: Matthew Ornstein, Atlanta, GA (US); Frank Schuler, Atlanta, GA (US); Ryan Ellison, Marietta, GA (US)

(21) Appl. No.: 13/116,151

(22) Filed: May 26, 2011

Related U.S. Application Data
(60) Provisional application No. 61/490,115, filed on May 26, 2011.

(51) Int. Cl. G06Q 40/00

(52) U.S. Cl. 705/37

(57) ABSTRACT

A system and method for minimizing the purchase costs to a buyer of Units in a multiple seller/single buyer auction environment are described. The method includes presenting sellers of Units with a buyer's demand and an initial per Unit price offer. Seller(s) may accept the offer by transmitting a quantity of Units to be associated with the acceptance. If no acceptance of the offer is received, or the total acceptances are less than the demand, the per Unit price offer may be incrementally increased. As acceptances are received, the demand may be reduced by the quantities associated with the acceptances and the remaining demand published to the auction participants. The process continues until the buyer's demand is filled or a maximum per Unit price is reached. If a maximum per Unit price is reached before the demand has been filled, some embodiments may publish a “last call” per Unit price.

### CROSS-REFERENCE TO RELATED APPLICATIONS

This is a United States application for patent filed under 35 USC §111 and 35 CFR §1.53(b) and claiming priority under 35 U.S.C. §119(e) to United States provisional application entitled “SYSTEM AND METHOD AUCTIONING IN A MULTIPLE SELLER/SINGLE BUYER ENVIRONMENT,” filed concurrently with the present application and assigned application Ser. No. 61/490,115. The entire contents of the above referenced provisional application are hereby incorporated by reference.

### BACKGROUND

It is often difficult for buyers and sellers of certain commodities that are not traded on a commodities exchange and/or commodities that require physical local delivery, or use, of the commodity to find each other. And, even when a buyer of such commodities finds a seller and engages in a transaction with the seller for the purchase of such commodities, the price per Unit of the commodities agreed upon between the parties is often higher than what the market should bear. Accordingly, what is needed is a system and method that may overcome the problems associated with the buying and selling of certain commodities. More specifically, a system and method is needed for an online auction system that is specifically designed to minimize the cost to the buyer of such commodities when employed in a multiple seller/single buyer auction environment.

### SUMMARY OF THE DISCLOSURE

A system and method for auctioning specifically measured, and/or defined, units of certain commodities (“Units”) in a multiple seller/single buyer auction environment are described. The method includes presenting a plurality of sellers of Units of a certain commodity with a single buyer's demand. The sellers and the buyer may participate in the auction by leveraging user interface devices which are configured for remote communication with a server. The server may publish the buyer's demand to the user interface devices along with an initial per Unit price offer. A seller may accept the offer by actuating the associated user interface device, which may be associated with unique login data, thus identifying the identity of the seller to the server, and transmitting a quantity of Units to be associated with the acceptance. If no acceptance of the initial offer is received by the server from any of the seller user interface devices within a certain time limit, the per Unit price offer may be incrementally increased until an acceptance is indicated. As acceptances are received by the server, the demand may be reduced by the quantities associated with the acceptances and the remaining demand subsequently published to the user interface devices. The process continues until either the buyer's demand is fulfilled or until a maximum per Unit price is reached. Notably, it is envisioned that in some embodiments the maximum per Unit price may be pre-set prior to commencement of the auction and/or kept confidential from participating sellers. If a maximum per Unit price is reached before the demand has been fulfilled, some embodiments may publish a “last call” per Unit price equal to the maximum per Unit price set by the buyer, in an effort to fulfill any remaining demand. The user interface devices may be operable to render any combination of data associated with the auction, as may be appropriate for the user associated with the particular user interface device.

One exemplary embodiment of the system and method may be employed when a buyer desires to purchase a specific type of commodity. Sellers of that specific type of commodity may be contacted and invited to attend an auction at a scheduled date and time. When the auction commences, the sellers may compete against each other to sell the buyer the commodities needed to satisfy all or, in some embodiments, part of the buyer's demand. In some embodiments, one or more of the sellers may not be informed as to how many other sellers are logged in and competing to sell the commodity needed by the buyer. As a result of this real time multiple seller/single buyer environment, an incentive can be created for a seller to sell a commodity at the lowest price that can be offered to the buyer.

In an exemplary embodiment, all sellers may be given a username and password to log into the auction. After logging into the auction, a seller may be informed as to how many Units of a certain commodity the buyer seeks to purchase at the particular auction. Each seller may also be prompted to indicate a quantity of Units of that certain commodity that they currently have available for sale. In some embodiments, the type and quantity of commodity Units indicated by the seller may be verified via privately or publicly maintained databases, or by the sellers themselves. Ideally, sellers will not be allowed to sell more Units than they actually have. Any Units that are sold to a buyer during the auction will be transferred to the buyer within a set period of time after the particular auction ends. In some embodiments, buyers may also be assigned an access username and password to monitor the auction in real time.

In the exemplary embodiment, the auction administrator may coordinate with the buyer before commencing the auction to determine an initial per Unit auction price that the buyer is willing to pay for the needed Units as well as the incremental amount by which the price will be increased over certain periods of time.

As a seller, when the price is incremented during the auction to an amount that is deemed acceptable to sell a quantity of Units, the offer can be accepted by indicating the quantity of Units to be sold at the current price. In some embodiments, sellers are allowed to sell Units in varying amounts and at different prices during the auction.

In an auction for Units that a buyer wants to purchase such as, for example, an auction for environmental mitigation credits which may include, but are not limited to stream mitigation credits or wetland mitigation credits, the price per Unit that the buyer is willing to pay will continue to rise by a given amount every certain amount of time until either (1) all the Units that the buyer needs have been purchased or (2) the price per Unit has reached the “Buyer's Maximum Price” for that auction. Notably, in some embodiments, a maximum price per Unit that the buyer is willing to pay per Unit will not be disclosed to the sellers unless the maximum price per Unit is reached at the auction and the buyer still needs to purchase more Units to fulfill demand.

When the exemplary auction embodiment is completed, sellers that have successfully sold Units to the buyer will receive a summary of how many Units they sold and at what per Unit prices. Similarly, the buyer may also receive a full auction summary at the end of each auction. It is envisioned that within a certain period of time, the buyer will wire funds owed to a seller into an escrow account maintained by a third party or, utilize some other payment methodology. When the buyer's funds have been confirmed in the escrow account, the seller will be prompted to transfer the promised number of Units to the buyer. Once the Units have been transferred, the escrowed funds may be transferred to the seller(s) bank account.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1A and FIG. 1B illustrate an exemplary method for auctioning commodities in a multiple seller/single buyer environment.

FIG. 2A is a high level diagram illustrating exemplary components of a system for auctioning commodities in a multiple seller/single buyer environment.

FIG. 2B is a functional block diagram illustrating exemplary aspects of a client computing device that may be included in the FIG. 2A system.

FIGS. 3A-3D collectively illustrate an exemplary application of the FIG. 1 method implemented in a configured embodiment of the FIG. 2 system.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed. Further, an “application” may be a complete program, a module, a routine, a library function, a driver, etc.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device” and “wireless handset” are used interchangeably. With the advent of third generation (“3G”) and fourth generation (“4G”) wireless technology, greater bandwidth availability has enabled more portable computing devices with a greater variety of wireless capabilities. Therefore, a portable computing device (“PCD”) may include a cellular telephone, a pager, a PDA, a smartphone, a navigation device, a tablet personal computer (“PC”), or a hand-held computer with a wireless connection or link.

In this application, the terms “commodity” and “Unit” is intended to envision any item, article, unit of service or thing that is traded, sold, purchased, and/or used in commerce where such item, article, unit of service or thing is identical, or functionally equivalent, to all other items, articles, units of service or things in the same class. As such, it will be understood by one of ordinary skill in the art that the particular item or service being transferred from one party to another as a result of any given embodiment of the disclosed systems and methods, or their equivalents, will not limit the scope of the disclosure or reach of the claims.

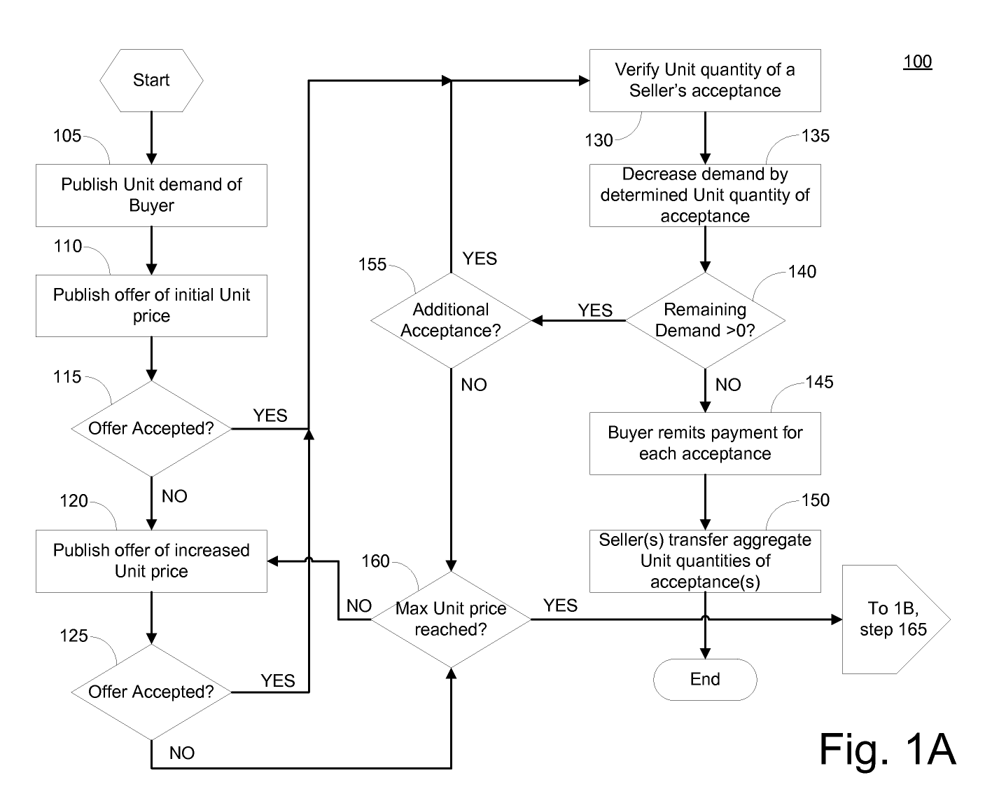

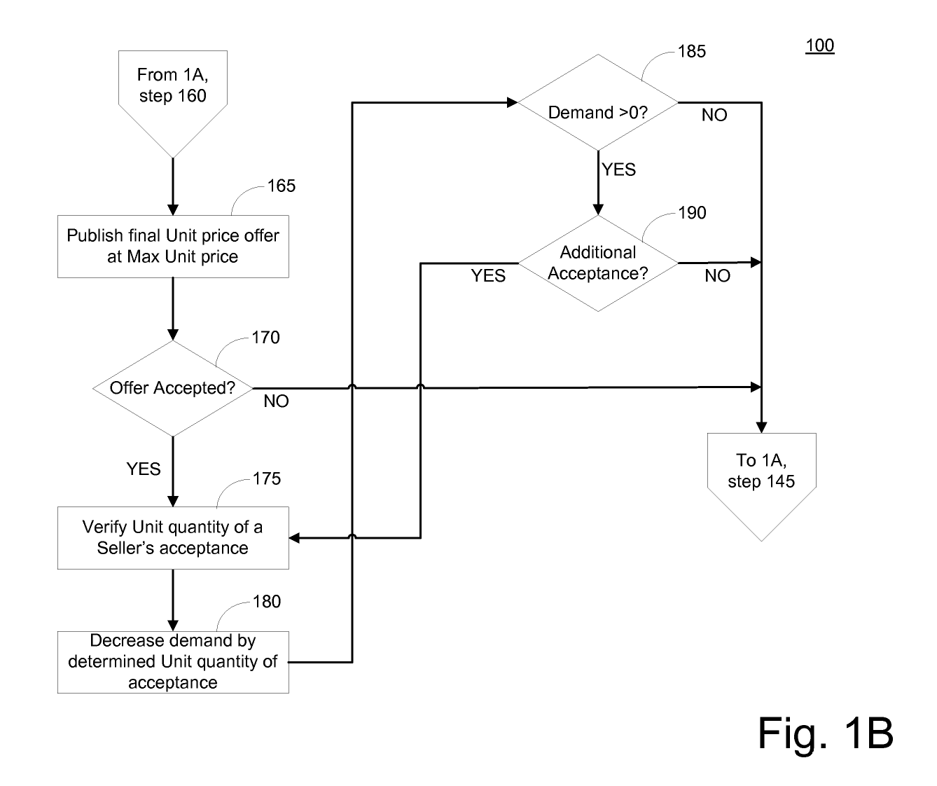

Referring to FIGS. 1A and 1B, these figures represent an exemplary “reverse auction” methodology 100 that may be employed in a multiple seller/single buyer (“MS/SB”) auction environment. Advantageously, the exemplary reverse auction methodology 100 serves to fill a buyer's demand at the lowest average cost per Unit achievable in the given multiple seller market. In an auction that is administered in a MS/SB environment, multiple sellers of like commodities may compete to fill, or incrementally fill, a demand.

Notably, in some embodiments, the aggregate commodity supply of the multiple sellers exceeds the demand of the single buyer, although aggregate seller supply exceeding buyer demand is not a prerequisite for application of all embodiments of the reverse auction methodology. Further, in such embodiments having a demand that exceeds the aggregate commodity supply of the one or more participating sellers, it is an envisioned advantage of some such embodiments that the participating seller(s) may not have access to data associated with competing sellers, thus creating a competitive auction environment wherein participating sellers may have an incentive to behave as if the aggregate supply exceeds the demand. For example, in some embodiments, a given seller may not know details associated with competing sellers such as, but not limited to, the total amount of Units a competitive seller has for sale, the identity of a competitive seller, the types of Units designated for sale by a competitive seller, the actual participation of a competitive seller, the amount of demand already filled by other sellers, etc. and, as such, may have an incentive to not “hold out” for higher per Unit price offers lest the demand be filled by another supplier. Moreover, one of ordinary skill in the art will recognize that limiting a participating seller's access to data associated with other participating sellers may be desirable regardless of whether demand exceeds supply or supply exceeds demand.

It is an advantage of the present auction methodology that the single buyer may fill, or at least partially fill, a predetermined demand at the lowest average sales price per Unit available in the given multiple seller market. More specifically, because the buyer makes an initial offer to buy Units at a given price and then periodically increases the offered price, the predetermined demand may be incrementally filled by the multiple, competing sellers as the increasing price offers are accepted for various quantities, thereby ensuring that Units are always purchased at the lowest possible price acceptable to the market of sellers. Advantageously to the buyer, to avoid missing a sale, the multiple sellers have an incentive under the present reverse auction model to accept the buyer's offer at the lowest acceptable price. It is also important to note that, in some embodiments, the sellers are unaware of exactly how many other sellers are attending the live auction and competing against each other to sell Units to the buyer. Advantageously, when sellers are not privy to auction attendance data, an intensified competitive selling environment may be created that encourages the sellers to sell their Units to the buyer at the seller's lowest acceptable price.

Turning to FIG. 1A, at the beginning of an auction in an MS/SB environment, the single buyer may state a demand 105. Importantly, while variations of the auction methodology described relative to FIG. 1 may be used in alternative auction environments having varied parameters such as, for example, an unlimited demand, a variable demand, a fluctuating demand or a modifiable demand, it is envisioned that some embodiments of the disclosed methodology will be deployed in an MS/SB environment having a predetermined, fixed demand. Notably, in such embodiments having a fixed demand published to the multiple participating sellers, an incentive may be created for participating sellers to accept price offers at the lowest acceptable price to avoid missing a sale altogether when the fixed demand is filled by a competitive seller(s). Moreover, it is envisioned that, in some embodiments, publishing of the actual fixed demand may not be necessary, as the mere knowledge that demand is fixed may be enough to create the incentive described above. Along these lines, it will be understood by those with ordinary skill in the art that various types of goods or services may be successfully auctioned using embodiments of the disclosed methodology and, as such, the specific types of goods or services auctioned using embodiments of the exemplary systems and methods will not limit the scope of the disclosure. Even so, for illustrative purposes only, it is envisioned that systems and methods disclosed herein will be particular well suited for the auctioning of commodity Units such as, but not limited to, any and all types of environmental mitigation credits, wetland mitigation credits, etc.

Once the buyer has published the demand 105, an offer of an initial price per Unit is published to the participating sellers 110. If any of the sellers accept the published offer 115, i.e. a seller or sellers agree to sell the buyer a given number of Units at the initial offered price (it is envisioned that some embodiments will require such agreement to occur within a time limit predetermined prior to commencement of the auction), then the quantity of Units agreed to be sold by the seller at the initial price is verified 130. Subsequently, the verified number of sold Units is subtracted from the demand 135. If the remaining demand for Units exceeds zero 140, then the existence of additional acceptances can be evaluated 155. In such event, if additional acceptances at the initial price are present, the Unit quantities associated with each additional acceptance can be verified 130 and subtracted 135 from the remaining demand. If no additional acceptances at the initially published or currently published price are present within a certain time limit, and the price per Unit has not reached a maximum Unit price agreeable to the buyer 160, the published price is increased 120.

Returning to acceptance action 115, if after a certain time no seller accepts the offer to sell Units at the initial published price 110, the initial Unit price is increased 120. If after a period of time the previously increased Unit price is determined to not have enticed a seller to accept the offer by selling a quantity of Units 125, and if the Unit price has not reached a maximum per Unit price agreeable to the buyer 160, the Unit price offer is again increased 120. The Unit price offer will continue to be periodically increased 120 until either a seller accepts the price by agreeing to sell a quantity of Units or until a maximum per Unit price agreeable to the buyer is reached 160.

The cycle of increasing the Unit price in an effort to solicit acceptances to sell quantities of Units is continued until either the remaining demand is calculated to be zero 140 or the buyer's predetermined maximum Unit price offer is reached 160. In such cases that the buyer's initial demand is filled, i.e. the aggregate of all Unit sales by the sellers meets the buyer's predetermined demand which was initially published 105, the buyer will remit payment 145 to each seller according to the quantity of Units sold by each seller times the per Unit price (initially published 110 or as increased 120) at which the seller agreed to make the sale. If the maximum per Unit price is reached 160 prior to the aggregate of Unit sales meeting the buyer's predetermined demand 105, the processing continues as illustrated in FIG. 1B.

Turning to FIG. 1B, if the maximum Unit price is reached 160 (FIG. 1A) and the published predetermined demand 105 has not been met, the buyer's maximum Unit price offer may be made known to participating sellers with remaining supply 165. This is referred to as the “last call”. It is envisioned that in some embodiments a “last call” offer of the maximum Unit price may not be made known to the sellers, however, some embodiments may include such a feature in an effort to entice auction clearing acceptances that will fill any remaining demand.

Similar to that which has been described above relative to FIG. 1A, if the published maximum Unit price is accepted by a seller, the Unit quantity of the acceptance is verified 175 and subtracted from the remaining demand 180. If the demand has not been met, then additional “last call” acceptances can be identified 190 and processed by again verifying the Unit quantity of the seller's acceptance 175 and decreasing the demand by the determined Unit quantity of acceptance 180 so long as the remaining demand exceeds zero 185. If all “last call” acceptances resulting from the publishing of the maximum Unit price 165 have been processed and no additional acceptances remain 190, or it is determined that the buyer's predetermined demand has been filled 185, or it is determined that no seller has accepted the maximum Unit price offer 170, the process continues as illustrated in FIG. 1A 145.

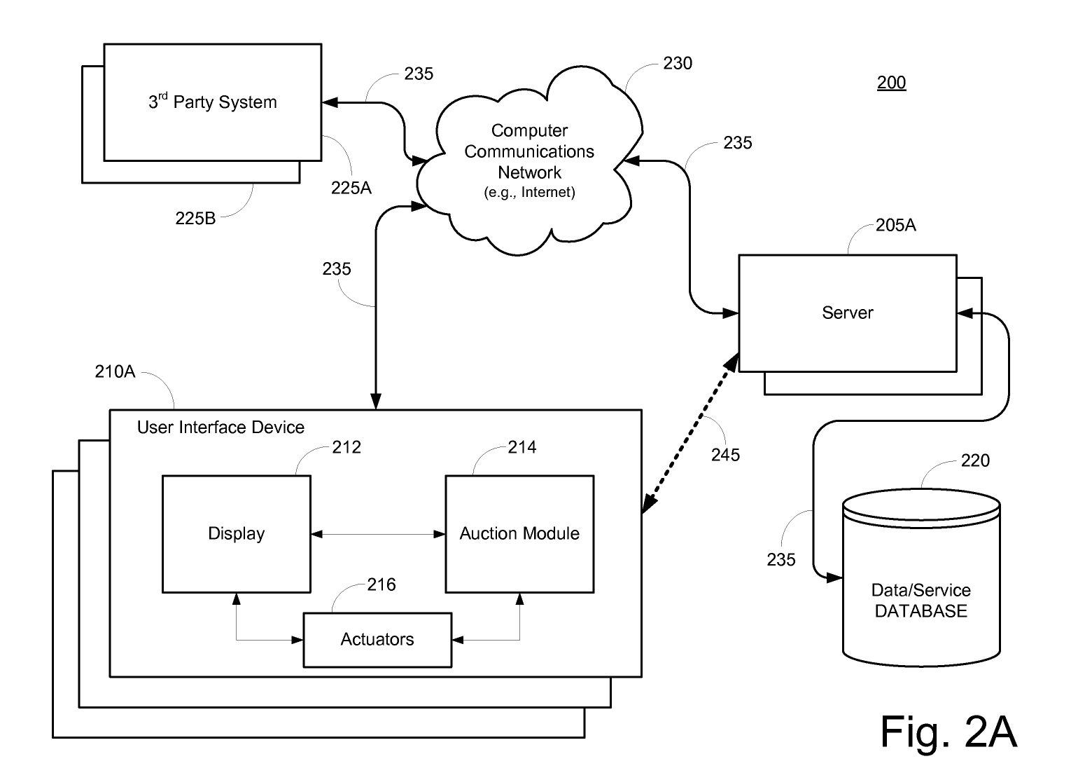

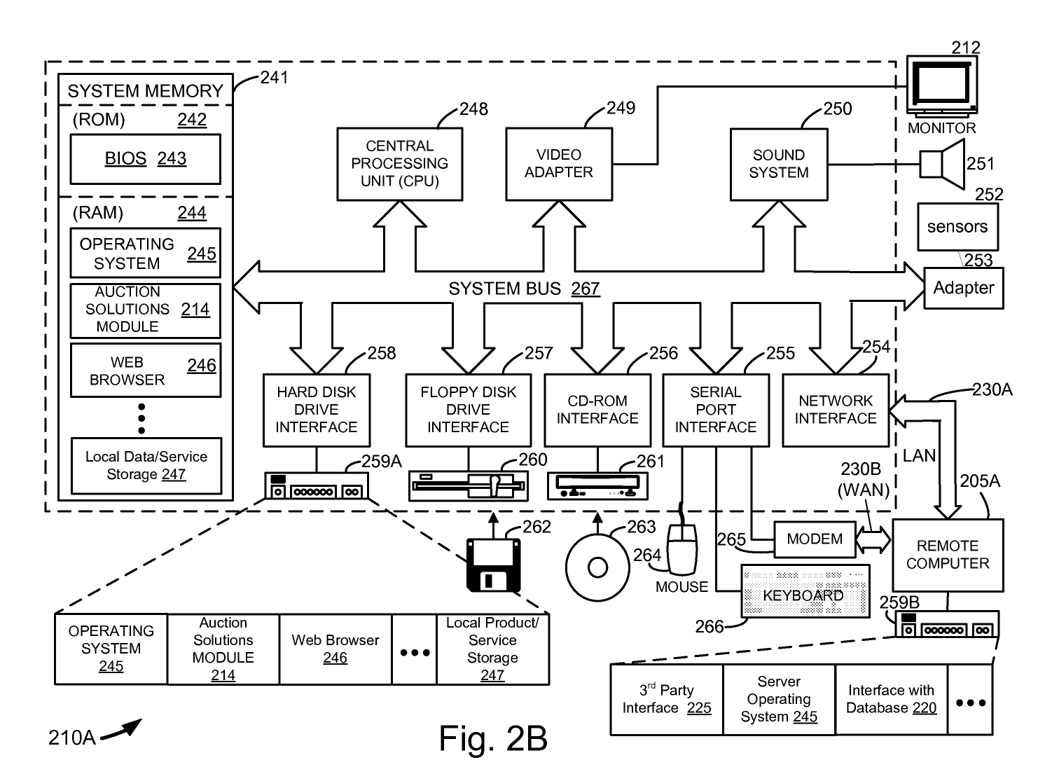

An exemplary embodiment of a reverse auction methodology suitable for a MS/SB environment in which it is desirable to minimize the total cost to a buyer to fill a demand has been described. Turning to FIG. 2, various features and aspects of a system suitable for implementation of the method described and depicted relative to FIG. 1, as well as anticipated variations thereof, are illustrated.

FIG. 2A is a high level diagram illustrating exemplary components of a system for auctioning commodities in a multiple seller/single buyer environment. The illustrated components of an exemplary system 200 auction goods and/or services such as, but not limited to, commodities, in a multiple seller/single buyer environment. Exemplary embodiments of a user interface device 210, such as the user interface illustrated in system 200 anticipate remote communication, real-time software updates, extended data storage, etc. and may be leveraged in various configurations by sellers and/or buyers in the auction environment. Advantageously, embodiments of user interface devices 210 configured for communication via a computer system such as the exemplary system 200 depicted in FIG. 2A may leverage the Internet for, among other things, software upgrades, content updates, third party database queries, etc. Other data that may be useful in connection with a user interface device 210, and accessible via the Internet or other networked system, will occur to those having ordinary skill in the art.

The illustrated computer system 200 can comprise a server 205 that can be coupled to a network 230 comprising any or all of a wide area network (“WAN”), a local area network (“LAN”), the Internet, or a combination of other types of networks. It should be understood that the term server may refer to a single server system or multiple systems or multiple servers. The server 205 can be coupled to a data/service database 220. The data/service database 220 can store various records related to, but not limited to, device configurations, software updates, user's manuals, troubleshooting manuals, Software as a Service (SaS) functionality, customized device configurations for specific auction applications, user-specific configurations, seller specific contact or account information, buyer specific contact or account information, historical content, laws, regulations, audio/video data, etc.

When the server 205 is coupled to the network 230, the server 205 can communicate through the network 230 with various different user interface devices 210 that may be comprised of desktop or laptop computers, thin clients, handheld devices such as personal digital assistants (“PDAs”), cellular telephones or other smart devices. Each user interface device 210 can run or execute web browsing software or functionality to access the server 205 and its various applications. Any device that can access the network 230 either directly or via tether to a complimentary device, can be a user interface device 210 according to the computer system 200. The user interface devices 210, as well as other components within system 200 such as, but not limited to, a database server (not specifically depicted) associated with data/service database 220 or third party systems 225, can be coupled to the network 230 by various types of communication links 235. These communication links 235 can comprise wired as well as wireless links. The communication links 235 allow each of the user interface devices 210 to establish virtual links 245 with the server 205.

Each user interface device 210 may include a display 212 and one or more actuators 216. The actuators 216 can capture any number of inputs such as, but not limited to, initial Unit price offers, Unit price offer increases, time increments for Unit price increases, acceptance of Unit price offers, sold Unit quantities, etc. The inputs captured by the actuators 216 may include user actions or processor actions. With regards to the display 212 of a user interface device 210, it is envisioned that the display 212 can comprise any type of display device such as a liquid crystal display (LCD), a plasma display, an organic light-emitting diode (OLED) display, a touch activated display, and a cathode ray tube (CRT) display, a brail display, an LED bank, a segmented display or even an audio device such as a speaker or buzzer.

A user interface device 210 can execute, run or interface to an auction module 214. The auction module 214 may comprise a multimedia platform that can be part of a plug-in for an Internet web browser. The auction module 214 is designed to work with the actuators 216, the display 212 and any stored or retrievable content to produce an auction interface on the display 212. Based on actuations detected by the auction module 214, the auction module 214 may run one or more algorithms or processes required for user participation in an auction event administered via server 205.

FIG. 2B is a functional block diagram illustrating exemplary aspects of a client computing device that may be included in the FIG. 2A system. It should be appreciated that the functional block diagram, or variations thereof may also present an environment suitable for other components in the system 200, including a server 205, a third party system 225, an auction module 214, a data/service database 220 as well as other components or sub-components. The illustrated functional block diagram of a user interface device 210A can be a computer or processing platform that, for example, can be used in the system 200 for participating in an auction according to an exemplary embodiment of the system. The exemplary operating environment for the system 200 includes a general-purpose computing device in the form of a conventional computer. Generally, the user interface device 210A includes a processing unit 248, a system memory 241, and a system bus 267 that couples various system components including the system memory 241 to the processing unit 248.

The system bus 267 may be any of several types of bus structures including a memory bus or memory controller, a peripheral bus, and a local bus using any of a variety of bus architectures. The system memory may include various memory components such as, but not limited to, a read-only memory (ROM) 242 and/or a random access memory (RAM) 244. A basic input/output system (BIOS) 243, containing the basic routines that help to transfer information between elements within user interface device 210A, such as during start-up, is stored in ROM 242.

The user interface device 210A, which may be a computer, can include a hard disk drive 259A for reading from and writing to a hard disk, not shown, and a memory card drive 260 for reading from or writing to a removable memory 262, such as a memory card, and an optical disk drive 261 for reading from or writing to a removable optical disk 263 such as a CD-ROM or other optical media. Hard disk drive 259A, and memory card drive 260, and optical disk drive 261 are connected to system bus 267 by a hard disk drive interface 258, a memory card drive interface 257, and an optical disk drive interface 256, respectively.

Although the exemplary environment described herein employs a hard disk 259A, and a removable memory card 262, and removable optical disk 263, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment without departing from the scope of the invention. Such uses of other forms of computer readable media besides the hardware illustrated will be used in smaller user interface devices 210A such as in cellular phones, personal digital assistants (PDAs) and/or thin clients. The drives and their associated computer readable media illustrated in FIG. 2B provide nonvolatile storage of computer-executable instructions, data structures, program modules, and other data for computer or user interface device 210A.

A number of program modules may be stored on hard disk 259, memory card 262, optical disk 263, ROM 242, or RAM 244, including an operating system 245, an auction software module 214, a web browser 246, and a local data/service database 247. Program modules include routines, sub-routines, programs, objects, components, data structures, etc., which perform particular tasks or implement particular abstract data types. Aspects of the present invention may be implemented in the form of a downloadable, client-side, browser based auction solutions software module 214 which is executed by the central processing unit 248A of the user interface device 210A in order to provide an auction interface for participation in an auction.

A user may enter actuations, commands and information into a user interface device 210A through input devices, such as a keyboard 266, a pointing device 264, a touch activated monitor 212 or other input means. Pointing devices may include a mouse, a trackball, a user's digit, and an electronic pen that can be used in conjunction with an electronic tablet. Other input devices (not shown) may include a microphone, joystick, game pad, an audio activated device, a PS3 or other game controller, satellite dish, scanner, or the like. These and other input devices are often connected to processing unit 248 through a serial port interface 255 that is coupled to the system bus 267, but may be connected by other interfaces, such as a parallel port, game port, a universal serial bus (USB), wireless port or the like.

The display 212 may also be connected to system bus 267 via an interface, such as a video adapter 249. As noted above, the display 212 can comprise any type of display devices such as a liquid crystal display (LCD), a plasma display, an organic light-emitting diode (OLED) display, and a cathode ray tube (CRT) display. The audio adapter 250 interfaces to and drives another alert element 251, such as a speaker or speaker system, buzzer, bell, etc.

The sensors 252 may also be connected to system bus 267 via an interface, such as an adapter 253. Among other sensing devices, the sensors 252 can comprise a video camera such as a webcam and can be a CCD (charge-coupled device) camera or a CMOS (complementary metal-oxide-semiconductor) camera. In addition to the monitor 212 and sensors 252, the user interface device 210A, comprising a computer, may include other peripheral input/output devices (not necessarily shown), such as speakers 251, printers, credit card readers, magnetic strip readers, bill acceptors, etc. Also, it will be understood that sensors 252 may be comprised within the housing of an embodiment of a user interface device 210A or, alternatively, communicably coupled to an embodiment of a user interface device 210A.

The user interface device 210A, comprising a computer, may operate in a networked environment using logical connections to one or more remote computers, such as the server 205A. A remote computer may be another personal computer, a server, a client, a router, a network PC, a peer device, or other common network node. While the server 205A or a remote computer typically includes many or all of the elements described above relative to the user interface device 210A, only a memory storage device 259B has been illustrated in the Figure. The logical connections depicted in the Figure include a local area network (LAN) 230A and a wide area network (WAN) 230B. Such networking environments are commonplace in offices, enterprise-wide computer networks, satellite networks, telecommunications networks, intranets, and the Internet.

When used in a LAN networking environment, the user interface device 210A, comprising a computer, may be coupled to the local area network 230A through a network interface or adapter 254. When used in a WAN networking environment, the user interface device 210A, comprising a computer, typically includes a modem 265 or other means for establishing communications over WAN 230B, such as the Internet. Modem 265, which may be internal or external, is connected to system bus 267 via serial port interface 255. In a networked environment, program modules depicted relative to the server 205A, or portions thereof, may be stored in the remote memory storage device 259B. It will be appreciated that the network connections shown are exemplary and other means of establishing a communications link between the computers may be used.

Moreover, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

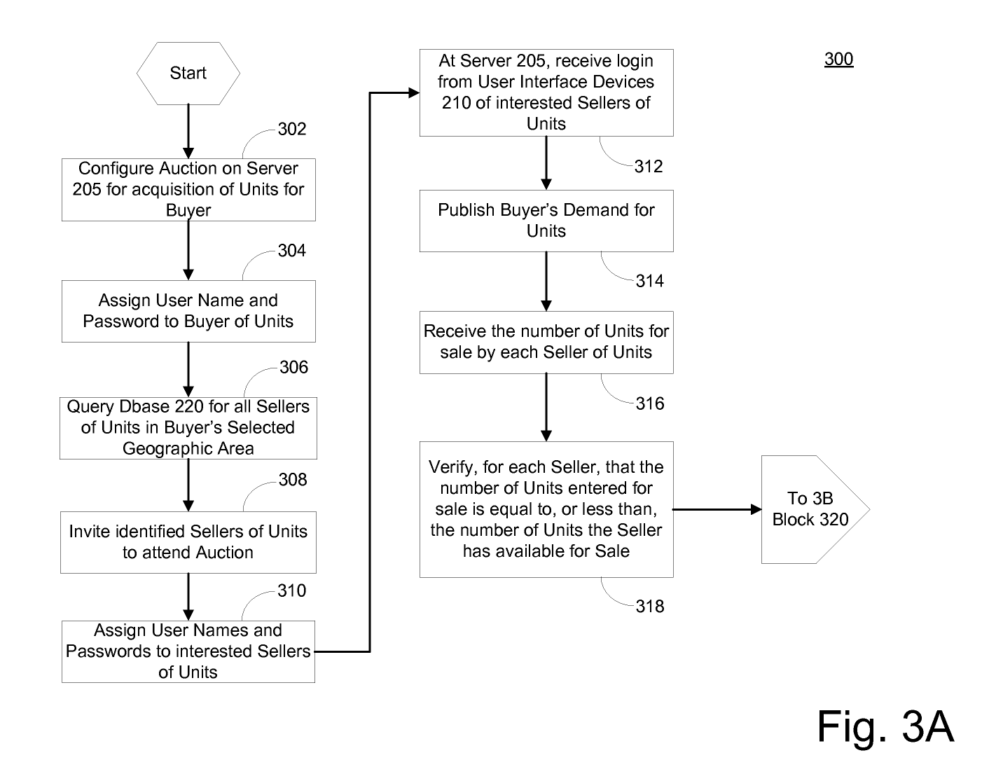

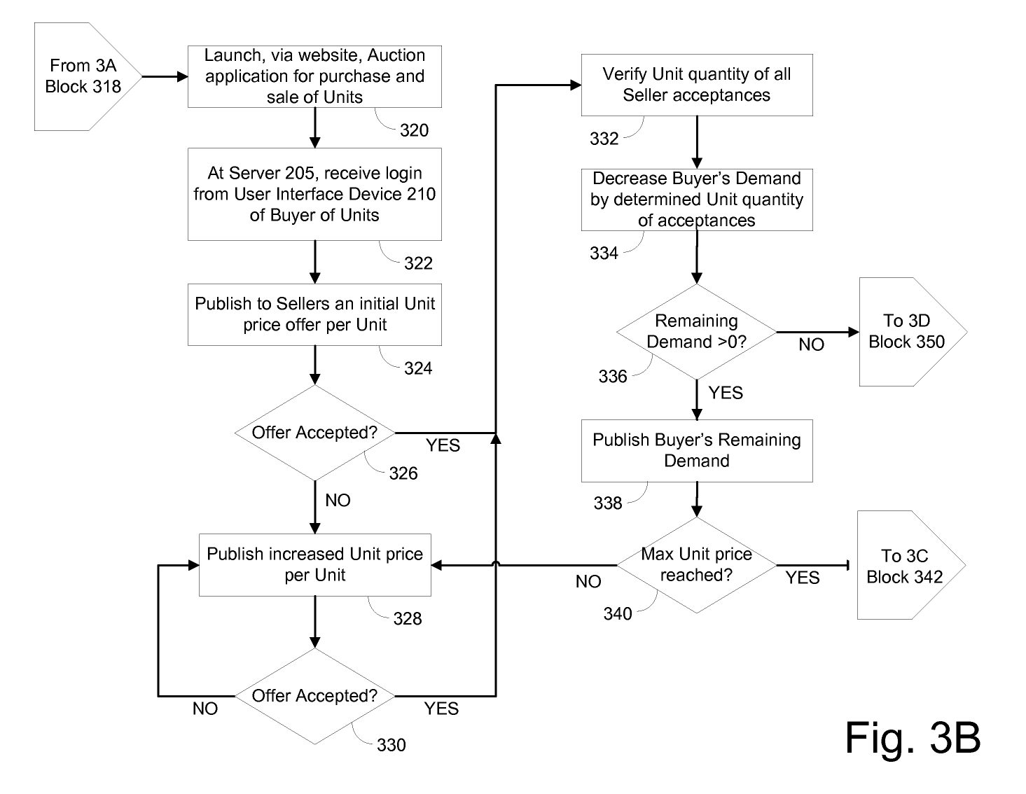

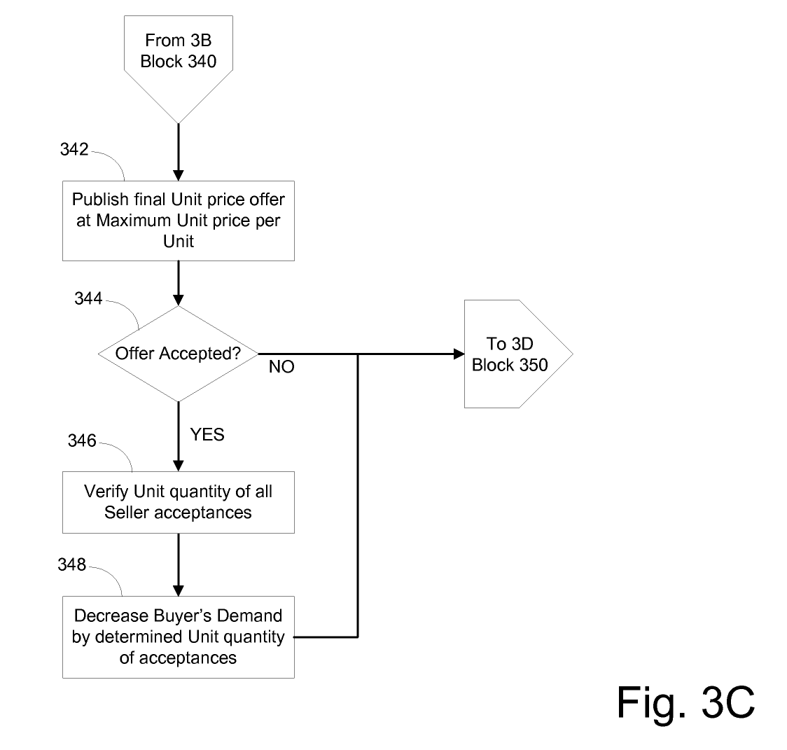

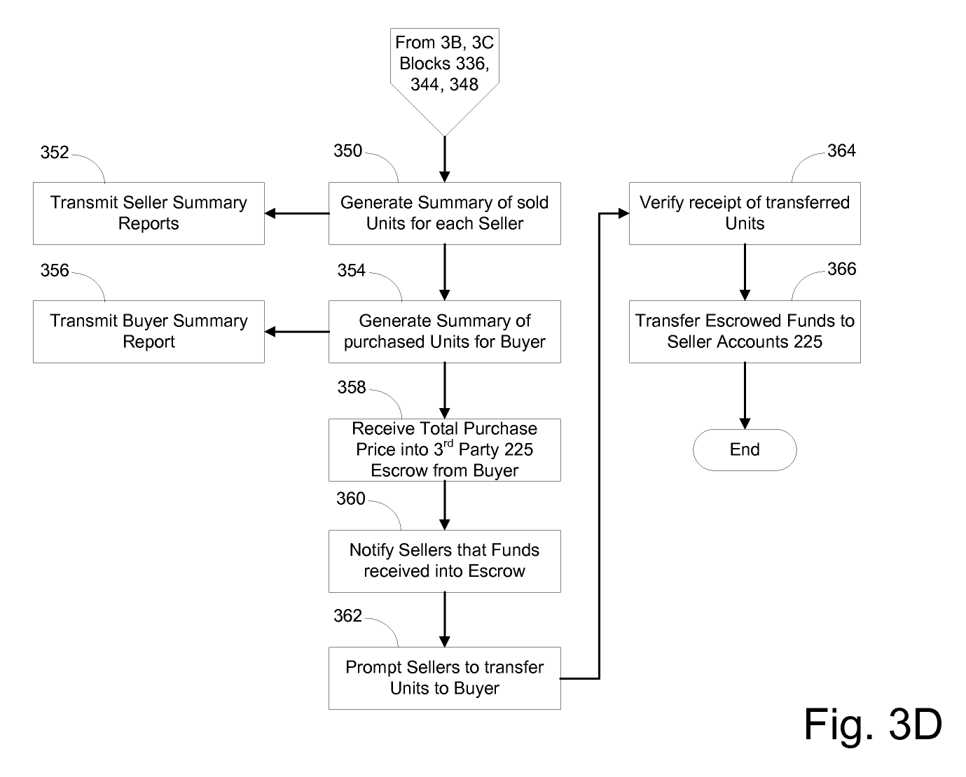

FIGS. 3A-3D collectively illustrate an exemplary application 300 of the FIG. 1 method implemented in a suitably configured embodiment of the FIG. 2 system. An exemplary embodiment of the application 300 may be leveraged for the purpose of, among other purposes, a single buyer acquiring a predetermined quantity of like commodity Units from a plurality of sellers of those commodity Units.

The FIG. 3 embodiment generally illustrates a reverse auction model leveraged for the sale and purchase of commodity Units via a website. An embodiment of the auction methodology described relative to FIG. 1 will be deployed in a multiple seller/single buyer auction environment wherein the single buyer's per Unit price bid ascends until the aggregate of sold Units resulting from accepted bids equals the total Units required by the buyer.

As an example, in operation, multiple sellers of a particular commodity (e.g., 3 sellers) representing an aggregate for-sale Unit volume (e.g., 130 Units) that exceeds the single buyer's total Unit demand (e.g., 75 Units) will accept the buyer's increasing price offers at various quantities until the buyer's demand is filled. Furthering the example above, consider the following bid table wherein the increasing bids correlate with time passed and the buyer's 75 Unit demand is filled at Bid 5 (thus ending the auction):

| | Seller 1 | | |
|---|---|---|---|
| | (30 Units | Seller 2 | Seller 3 |
| | for sale) | (50 Units for sale) | (50 Units for sale) |
| Bid 1 = $10/Unit | sells 5 Units | no sale | Sells 10 Units |
| Bid 2 = $15/Unit | no sale | no sale | no sale |
| Bid 3 = $20/Unit | sells 5 Units | no sale | no sale |
| Bid 4 = $25/Unit | sells 20 Units | no sale | sells 10 Units |
| Bid 5 = $25/Unit | no sale | sells 25 Units | no sale |
| (Buyer's Max | | | |
| Price) | | | |

Considering the above auction scenario in the context of the FIG. 3 embodiment, at block 302 an auction administrator may initially configure server 205 for presentation and hosting of a particular commodity Unit auction to purchase 75 Units for a single buyer. The configuration of the server 205 may include the configuration of a website, having controlled access for interested parties to the given commodity Unit auction, as is known in the art. Along these lines, at block 304 the single buyer may be assigned a user name and password operable to be used by the buyer for gaining access to the online auction website. Advantageously, embodiments that assign a user name and password to the buyer of commodity Units may provide a degree of anonymity to the buyer, thereby avoiding potential conflicts of interest that may arise during the auction as a result of a buyer's relationship with one or more sellers.

Once server 205 has been configured for hosting of the online auction, database 220 may be queried at block 306 for identification of qualified and potentially interested sellers of commodity Units. It will be understood that database 220 may be a private database or publicly accessible database. In some embodiments, database 220 may be under the exclusive control of an auction administrator. In other embodiments, database 220 may be a publicly accessible database such as, for example, a database maintained by the U.S. Army Corps of Engineers (“USACE”) which includes Unit release schedules for owners of a particular commodity such as, but not limited to, environmental mitigation credits.

At block 308, qualified sellers of particular Units may be invited to attend the Unit auction. In some embodiments, seller invitations may be distributed electronically from server 205 via email, SMS texting or other methods of electronic communication, however, not all embodiments will include an equivalent feature. For those sellers of particular Units who are interested in participating in the Unit auction, at block 310 user names and passwords may be assigned. Similar to that which is described above relative to the buyer, it is an advantage in some embodiments that the sellers maintain anonymity during the auction, by way of user names and passwords, in order to avoid conflicts of interest with other auction participants.

At or near the designated time for the Unit auction, at block 312 server 205 may receive logins from the buyer and sellers. Using the assigned user names and passwords from blocks 304 and 310, the buyer and sellers may leverage remote devices 210 to access the auction hosted by server 205. As described above relative to FIG. 2, user interface devices 210 may communicate with server 205 through any number of wired or wireless connections.

At block 314, the buyer's demand for particular Units is published for the benefit of the sellers. In most embodiments, “publishing” envisions posting the data via an Internet website, email, SMS messaging or other digital means, for the benefit of auction participants, however, it will be understood that not all embodiments will necessarily make available all the data described herein to be published in an exemplary embodiment.

Notably, in some embodiments the demand may be determined prior to launch of the auction while in other embodiments the buyer may enter a demand at the time of auction via a remote device 210. At block 316, sellers may each designate the total number of Units available for sale at the auction. Referring to the table associated with the exemplary scenario above, Seller 1 has 30 Units for sale and Sellers 2 and 3 each has 50 Units for sale. Prior to launch of the auction, in some embodiments, at block 318 server 205 may access a database 220 such as, for example, a USACE database to verify that a seller, in fact, does have the correct type and amount of Units available for sale. In other embodiments, the verification at block 318 may include verification by other means such as, for example, confirmation with the seller, transfer of Units into an escrow, or seller acceptance of contractual terms.

Once the buyer has stated a demand (75 Units per the example above) and the sellers have posted available quantities for sale (30 Units, 50 Units and 50 Units, respectively, per the example above), the online auction may be launched at block 320 (FIG. 3B). In the exemplary embodiment, the online auction may be launched via a website controlled by the auction administrator entity. Though not required in all embodiments, the buyer may leverage an assigned user name and password from block 304 in order to access the online auction at block 322.

At block 324, an initial price per Unit is published to the sellers. Referring back to the exemplary scenario above, the initial offered price per Unit is $10. At block 326, the initial price per Unit offered is accepted by Seller 1 and Seller 3. At the $10 per Unit price, Seller 1 accepted the offer and elected to sell 5 of his 30 available Units. Likewise, Seller 3 accepted the offer and elected to sell 10 of his 50 available Units. The amounts of each acceptance are verified at block 332 and subtracted from the demand required by the buyer (75 Units) at block 334. Because Seller 1 and Seller 3 have elected to sell a combined total of 15 Units, it is determined at block 336 that the remaining demand of 60 Units (75 Units minus 15 Units) is greater than zero. The remaining demand of 60 Units is published at block 338 to all sellers participating in the auction.

At block 340, it is determined that the buyer's maximum per Unit price of $25 has not been reached (only a $10/Unit price has been offered). Consequently, the offered price per Unit is increased at block 328 by a predetermined increment and is published as $15 per Unit. It should be understood that in some embodiments, the incrementing of the price per Unit at each stage may be automatic, such as after a selected or predetermined period of time, while in other embodiments, the buyer may be queried to enter a new price or accept an increment of the price. In addition, the increment time interval may vary depending on the number of sellers, the number of Units available or other criteria. In the exemplary scenario, at block 330 no Sellers accept the offer of $15/Unit and, subsequently at block 328, the offered price per Unit is incrementally increased from $15/Unit to $20/Unit.

Returning to block 330, the $20/Unit offer is accepted by Seller 1 for the sale of 5 Units. Similar to that which is described above, at block 332 the quantity of Units agreed to be sold by Seller 1 at the $20/Unit price is verified and subtracted at block 334 from the remaining demand. At block 336, it is determined that the remaining demand of 55 Units (previous remaining demand of 60 Units minus the 5 Units sold by Seller 1) is greater than zero, i.e. the buyer's demand has not been fully filled. The remaining demand of 55 Units is published at block 338 and it is determined at block 340 that the buyer's maximum price per Unit has not been reached. Notably, in some embodiments, the buyer's maximum price per Unit may not be made available to the sellers, as doing so could skew incentives on the part of the sellers and cause “hold out” for a higher price offer. Moreover, while it is not required in all embodiments that the buyer's maximum price be kept in confidence, or even that the buyer have a maximum price at all, a prematurely published maximum price, especially in an auction in environment where sellers may know the identity of other sellers, could introduce collusion on the part of the sellers. For such reason, it is an advantage of some embodiments that the identities of the auction participants and preset parameters of the auction such as, for example, the buyer's maximum price per Unit and the sellers' Unit quantities available for sale may be kept in confidence.

The offered price per Unit is again incremented at block 328 to $25/Unit. At the $25/Unit price, in the exemplary scenario it is determined at block 330 that Sellers 1 and 3 agree to sell 20 Units and 10 Units, respectively. For illustrative purposes, assume that the acceptance of Seller 1 preceded the acceptance of seller 3. After the quantity of Seller 1 is verified at block 332 to be 20 Units, 20 Units are subtracted at block 334 from the previously remaining demand to generate a new remaining demand of 35 Units (55 Units minus 20 Units) which is determined at block 336 to be greater than zero. Because the new remaining demand is still greater than zero, thus the buyer's total demand has not been filled, the system 200 may process the subsequent 10 Unit acceptance of Seller 3.

After processing the 10 Unit acceptance of Seller 3, the remaining demand it determined at block 336 to be 25 Units (35 Units minus 10 Units). The remaining demand of 25 Units is published to all auction participants at block 338. Notably, although many embodiments publish demands, remaining demands or price offers to all participants in a given auction, it is envisioned that some embodiments may selectively publish or offer prices based on various parameters specific to the given auction. For instance, it may be advantageous in some embodiments to offer initial low price per Unit to select sellers based on historical business relationships, contractual conditions precedent to the auction, combinations of Unit types available via a certain seller, etc. Reasons and conditions for selectively publishing or offering to certain sellers will occur to those with skill in the art and, as such, the presence or absence of such aspects in a given embodiment will not limit the scope of a system and method for an ascending price auction in a MS/SB environment.

Returning to the exemplary scenario outlined above, at block 340 it is determined that the current offered price per Unit of $25 is equivalent to the buyer's maximum Unit price. In such event, some embodiments may be configured to publish at block 342 (FIG. 3C) the maximum price per Unit. By publishing an offered price per Unit under the banner of it being the buyer's maximum price per Unit, a “last call” incentive may be created for sellers to fill the remaining demand. In the exemplary scenario, the maximum price per Unit offer of $25 is reiterated at block 342 and accepted at block 344 by Seller 2 for the sale of 25 Units. The acceptance of Seller 2 to sell 25 Units is verified at block 346 and subtracted from the previous remaining demand of 25 Units at block 348 to render the remaining demand zero.

The “last call” acceptance by Seller 2, in the exemplary scenario, serves to completely fill the demand of the buyer as it was initially published at block 314. At such point, the system 200 advances the auction methodology to block 350 (FIG. 3D) for post auction events. Similarly, had no seller accepted the “last call” maximum price offer, the exemplary embodiment of FIG. 3 would advance to block 350 despite unfilled demand. Likewise, returning to block 336, if the remaining demand is calculated to be zero, and the maximum price per Unit has not been offered, the particular embodiment illustrated by FIG. 3 would advance the auction methodology to block 350.

Regarding the maximum price per Unit that may be offered by a buyer, the particular embodiment illustrated in FIG. 3 assumes the maximum price per Unit to be both predetermined by the buyer prior to the auction and the last incremented price in the ascending price auction. It will be understood, however, that not all embodiments require that a buyer predetermine a maximum price per Unit that may be offered in an auction. For instance, it is envisioned that some embodiments will provide for the buyer to designate a no maximum price or a maximum price “on the fly,” i.e. some embodiments may provide for the buyer to designate during an ongoing auction that an incremented price is the maximum price that will be offered.

Moreover, it is envisioned that some embodiments will not define a maximum price per Unit as a set price but, rather, as an average price per Unit. In such embodiments which define a maximum price per Unit as the average price per Unit that will be paid by buyer, the “last call” price may be offered to the sellers in association with a calculated, mandatory quantity such that, if accepted by a seller, the average price paid per Unit over the course of the auction will equate to a buyer's stated maximum per Unit price.

Turning to FIG. 3D, at block 350, the exemplary embodiment may generate a summary report for the benefit of each participating seller. The summary report may include, among other data, the number of Units sold by the given seller, the price per Unit, a timeline for transfer of the Units, contractual terms and conditions, etc. Once generated 350, at block 352 the reports may be transmitted to the given sellers. Similarly, at blocks 354 and 356, a buyer's summary report may be generated and transmitted to the buyer. It is envisioned that the reports may be emailed, printed and mailed, securely posted on the auction website, linked to on a website or otherwise provided to the recipients in ways that will occur to those with ordinary skill. Further, while the data embodied in a given report, the presentation of the data in a given report or the method of report dissemination may be novel and unique to some embodiments, such will not be a limiting factor on the scope of the disclosure.

Once the auction has concluded, and the total price to be paid by the buyer has been calculated, the buyer may remit payment for the purchased Units via electronic fund transfer or other means for remittance of payment. In the FIG. 3 embodiment, the total purchase price owed by the buyer may be securely transmitted at block 358 into a third party escrow account 225. Verification that the funds have been transferred to the third party escrow account 225 may prompt at block 360 that the sellers be notified for transfer of the Units sold. Similar to the buyer transferring funds to a third party escrow account, the various sellers may transfer at block 362 the sold Units to the buyer. Once funds have been verified at block 358 to be in escrow, and Units have been verified at block 364 to have been transferred to the buyer, the escrowed funds may be distributed at block 366 to the various sellers according to the prices per Unit individually accepted by the sellers during the auction. The exemplary process thus concludes.

Notably, in some embodiments, it is envisioned that the buyer and sellers may not view the same data. For instance, a buyer's viewing page may include a maximum price ceiling or a breakdown of how many Units have been sold by various sellers whereas for strategic purposes such information may be kept secret from the various sellers. Similarly, a seller's viewing page may include data specific to the seller that should not be shared with other participants.

Certain steps in the processes or process flows described in this specification naturally precede others for the invention to function as described. However, the invention is not limited to the order of the steps described if such order or sequence does not alter the functionality of the invention. That is, it is recognized that some steps may be performed before, after, or parallel to (substantially simultaneously with) other steps without departing from the scope and spirit of the invention. In some instances, certain steps may be omitted or not performed without departing from the invention. Further, words such as “thereafter,” “then,” “next,” “subsequently,” etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for auctioning Units of commodities through a computer network comprising a host server in communication with one or more user interface devices, the method comprising the actions of:
confirming auction participation of a single buyer of Units and a plurality of sellers of Units, wherein the buyer and each of the plurality of sellers is in communication with the server via associated user interface devices;
receiving a number of Units for sale from one or more sellers, wherein an aggregate seller supply of Units is the sum of the Units for sale by the one or more sellers;
receiving a demand for Units specified by the single buyer;
publishing to the user interface devices of each of the plurality of sellers a per Unit price offer, wherein the per Unit price offer is periodically raised in increments over the course of the auction; and
receiving confirmation from one or more of the plurality of sellers that a per Unit price offer has been accepted, wherein a quantity of Units to be sold is associated with an acceptance.

2. The method of claim 1, further comprising the action of publishing to the user interface devices of each of the plurality of sellers a remaining demand, wherein the remaining demand is calculated by subtracting the aggregate quantity of Units associated with acceptances from the demand.

3. The method of claim 2, further comprising the action of receiving confirmations until the aggregate quantity of Units associated with acceptances equates to the demand for Units.

4. The method of claim 2, wherein the per Unit price offer is raised in accordance with a time schedule in increments until a maximum per Unit price is reached.

5. The method of claim 4, wherein the maximum per Unit price is set before commencing the auction and is not revealed to the sellers until the maximum price per Unit is reached during an auction.

6. The method of claim 4, further comprising the step of publishing to the user interface devices of each of the plurality of sellers the maximum per Unit price offer, wherein the maximum per Unit price offer is associated with a remaining demand.

7. The method of claim 6, wherein the maximum per Unit price associated with the remaining demand is a function of the average per Unit price of the aggregate quantity of Units associated with acceptances.

8. The method of claim 1, wherein the Units to be auctioned are environmental mitigation credits.

9. The method of claim 1, further comprising the step of qualifying the sellers of Units by verifying that each seller possesses a certain type and quantity of Units.

10. The method of claim 1, further comprising the actions of:
transferring into a third party account a fund amount that comprises the sum of the price totals of confirmed acceptances associated with a given one of the plurality of sellers, wherein a price total of an acceptance is calculated by multiplying the quantity of Units associated with the acceptance by the per Unit price offer associated with the acceptance;
transferring from the given seller's account to the buyer's account, the aggregate quantity of Units associated with the acceptances of the given seller; and
transferring the fund amount from the third party account to the given seller's account.

11. A computer system for auctioning Units in an auction environment in which any particular auction includes a single buyer and multiple sellers, the computer system comprising:
a server in communication with a plurality of user interface devices, the server:
confirms auction participation of the single buyer and the plurality of sellers;
receives a demand for Units;
publishes the received demand;
publishes a per Unit price offer, wherein the per Unit price offer is periodically raised in price increments over the course of the auction; and
receives confirmation that a per Unit price offer has been accepted, wherein a quantity of Units to be sold is associated with an acceptance;
a user interface device associated with the single buyer that:
transmits to the server confirmation of participation in the auction;
transmits to the server a demand for Units;
transmits to the server a maximum price per Unit;
renders a published demand; and
renders a published per Unit price offer; and
a plurality of user interface devices associated with individual sellers, wherein each user interface device is configured to:
transmit to the server confirmation of participation in the auction;
transmit to the server a published supply of Units for each seller
render a published per Unit price offer;
render a published demand; and
transmit to the server an acceptance of a per Unit price offer.

12. The computer system of claim 11, wherein the server further publishes, and the user interface devices further render, a remaining demand, wherein the remaining demand is calculated by subtracting the aggregate quantity of Units associated with acceptances from the demand.

13. The computer system of claim 12, wherein the server further receives confirmations until the aggregate quantity of Units associated with acceptances equates to the demand for Units.

14. The computer system of claim 12, wherein the server further raises the per Unit price offer in increments until a maximum per Unit price is reached.

15. The computer system of claim 14, wherein the maximum per Unit price is set before commencing the auction and is not revealed to the sellers until the maximum price per Unit is reached during an auction.

16. The computer system of claim 14, wherein the server further publishes, and the user interface devices further render, the maximum per Unit price offer, wherein the maximum per Unit price offer is associated with a remaining demand.

17. The computer system of claim 16, wherein the maximum per Unit price associated with the remaining demand is a function of the average per Unit price of the aggregate quantity of Units associated with acceptances.

18. The computer system of claim 11, wherein the server further qualifies the sellers of Units by verifying that the seller possesses a certain type and quantity of Units.

19. The computer system of claim 18, wherein the server is in further communication with a database managed by a third party.

20. The computer system of claim 11, wherein the server further:
verifies and confirms to a given seller that a fund amount comprising the sum of the price totals of confirmed acceptances associated with the given seller has been transferred into a third party account, wherein a price total of an acceptance is calculated by multiplying the quantity of Units associated with the acceptance by the per Unit price offer associated with the acceptance;
verifies and confirms to the buyer that the aggregate quantity of Units associated with the acceptances of the given seller have been transferred from the given seller's account to the buyer's account; and
verifies and confirms to the given seller that the fund amount has been transferred from the third party account to the given seller's account.
